(19) United States
(12) Patent Application Publication
(10) Pub. No.: US 2025/0175098 A1
(43) Pub. Date: May 29, 2025

(54) PIEZOELECTRIC MEMS DEVICE, IN PARTICULAR MICRO-ACTUATOR, AND MANUFACTURING PROCESS THEREOF

(71) Applicant: STMicroelectronics International N.V., Geneva (CH)

(72) Inventors: Domenico GIUSTI, Caponago (IT); Marco FERRERA, Concorezzo (IT); Lorenzo TENTORI, Verano Brianza (IT)

(73) Assignee: STMicroelectronics International N.V., Geneva (CH)

(21) Appl. No.: 18/947,912

(22) Filed: Nov. 14, 2024

(30) Foreign Application Priority Data
Nov. 23, 2023 (IT) 102023000024957

(51) Int. Cl. H02N 2/10; H02N 2/00

(52) U.S. Cl. CPC H02N 2/103; H02N 2/22

(57) ABSTRACT

The present disclosure is directed to a MEMS device having a first and a second actuator element, of piezoelectric type and a first and a second arm. The first and a second actuator element are configured to generate respective alternate, approximately linear, movements of an own end portion along a first and, respectively, a second direction, the second direction transverse to the first direction. The first arm has a first end rigid with the end portion of the first actuator element. The second arm extends transversally to the first arm and has a first end coupled rigid with the end portion of the second actuator element and a second end coupled rigid with the first arm. The first and the second actuator elements are configured to be driven in an offset manner, so that the second end of the first arm performs a movement along a closed line.

### BACKGROUND

### Technical Field

The present disclosure relates to a piezoelectric micro-electromechanical system (MEMS) device, in particular a micro-actuator, and to the manufacturing process thereof. Specifically, the present disclosure refers to a MEMS device having a controllable member to perform movements along a closed line, for example circular or elliptical movements.

### Description of the Related Art

As known, MEMS technology allows micro-mechanical components of very small dimensions to be formed, using semiconductor materials and manufacturing techniques, and therefore at low costs compared to the assembly of prefabricated parts. It also allows miniaturization of structures, which allows the use of MEMS structures even in very small devices and apparatuses.

Among other applications, MEMS technology has been used to provide very small microactuators and micromotors, capable of manipulating micrometric and sub-micrometric structures.

Lately, in these devices, thin films of piezoelectric materials, such as PZT (lead zirconium titanate), are used to control the movement of movable parts, thanks to the advantageous characteristics of these materials.

Current microactuators and micromotors of this type allow actuation of simple movements; it is therefore desired to have microactuators and micromotors capable of carrying out more complex movements.

For example, an experimental system capable of actuating elliptical movements of movable members of micrometric dimensions has already been proposed, for example for the rotary control of a rotating element; however, this system is not integrated, has rather large overall dimensions, with an area of a few dm² and cannot be manufactured using an industrial process.

Various embodiments of the present disclosure provide a MEMS device capable of generating circular/elliptical movements of micrometric and sub-micrometric dimensions.

### BRIEF SUMMARY

According to the present disclosure, a MEMS device and the manufacturing process thereof are provided.

The MEMS device includes a first and a second actuator element, of piezoelectric type and a first and a second arm. The first and a second actuator element are configured to generate respective alternate, approximately linear, movements of an own end portion along a first and, respectively, a second direction, the second direction transverse to the first direction. The first arm has a first end rigid with the end portion of the first actuator element. The second arm extends transversally to the first arm and has a first end coupled rigid with the end portion of the second actuator element and a second end coupled rigid with the first arm. The first and the second actuator elements are configured to be driven in an offset manner, so that the second end of the first arm performs a movement along a closed line.

### BRIEF DESCRIPTION OF THE SEVERAL VIEWS OF THE DRAWINGS

For a better understanding of the present disclosure, embodiments thereof are now described, purely by way of non-limiting example, with reference to the attached drawings, wherein:

FIG. 1 is a top perspective view of one embodiment of the present MEMS device;

FIG. 2 is a top-plan view of a detail of the MEMS device of FIG. 1, on an enlarged scale;

FIG. 3 is a top perspective view, partially interrupted in a vertical plane and rotated by 90° with respect to FIG. 1, of the present MEMS device;

FIG. 4A is a perspective view of the MEMS device of FIG. 3, partially interrupted in a vertical plane perpendicular to that of FIG. 3, during operation, in a first deformed condition;

FIG. 4B is a perspective view, similar to FIG. 4A, in a second deformed condition;

FIG. 5 shows a plot of driving voltages for the MEMS device of FIG. 1;

FIGS. 6A-6D show a detail of the MEMS device of FIG. 1, in different operating stages;

FIG. 7 is a top perspective view of the MEMS device of FIG. 1, used as a micro-actuator to actuate rotation of a rotating member;

FIGS. 8A-15A are cross-sections through a wafer of semiconductor material in subsequent manufacturing steps;

FIGS. 8B-15B are top views on the wafer of FIGS. 8A-15A in subsequent manufacturing steps, wherein FIGS. 8A-15A and 7B-15B having equal Figure numbers refer to a same manufacturing step;

FIG. 12C shows a cross-section of the wafer of FIGS. 12A and 12B, taken along section line XII-XII of FIG. 12B, in the same manufacturing step;

FIG. 13C shows a cross-section, taken along the same section line as FIG. 12C, in the same manufacturing step as FIGS. 13A and 13B;

FIG. 13D is a perspective view, partially interrupted along line XIII-XIII of FIG. 13B, of a detail of the wafer of FIGS. 13A, 13B and 13C, in the same manufacturing step; and

FIG. 16 is a cross-section similar to FIG. 15A, of a different embodiment.

### DETAILED DESCRIPTION

The following description refers to the arrangement shown; consequently, expressions such as “above”, “below”, “upper”, “lower”, “right”, “left” relate to the attached Figures and are not to be interpreted in a limiting manner.

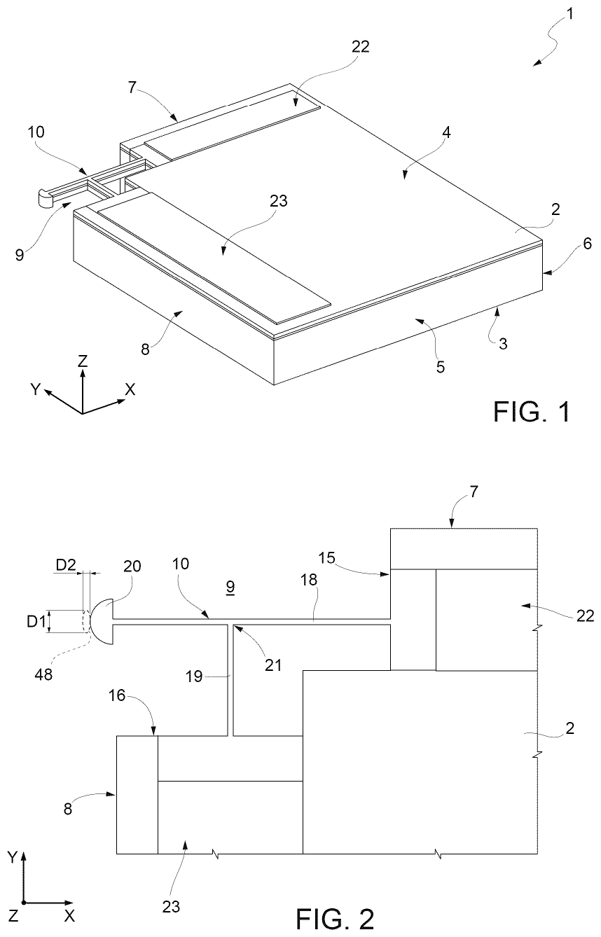

FIG. 1 shows a MEMS device 1, for example a micro-actuator operating as a micromotor, formed into a die 2 processed using semiconductor technology.

The die 2 is a substrate and has a generally parallelepiped shape, defined by a lower surface 3, an upper surface 4, a first, a second, a third and a fourth lateral surface 5-8.

Two adjacent lateral surfaces, for example the first and second lateral surfaces 5, 6, are generally planar; two other adjacent lateral surfaces, in the example the third and the fourth lateral surfaces 7, 8, have a common edge, hereinafter referred to as recessed edge 9, having an actuation structure 10, integral with the die 2, extending therein.

In detail, see FIG. 2, the recessed edge 9 is mainly delimited by a first lateral wall 15, extending from and transversally to the third lateral surface 7, and by a second lateral wall 16, extending from and transversally to the fourth lateral surface 8.

The actuation structure 10 comprises a first arm 18, a second arm 19 and a tip or punch 20.

The first arm 18 extends from the first lateral wall 15, transversely thereto and parallel to the third lateral surface 7 of the die 2 (parallel to a first Cartesian axis X of a coordinate system XYZ), approximatively inside the recessed edge 9.

The second arm 19 extends from the second lateral wall 16, transversely thereto and parallel to the fourth lateral surface 8 of the die 2 (parallel to a second Cartesian axis Y of the coordinate system XYZ), up to the first arm 18, and is connected thereto, approximately halfway therealong (connecting point 21).

The tip 20 is formed at the free end of the first arm 18 and has a rounded shape, for example a semi-cylindrical shape (semi-circular in top view of FIG. 2). In the embodiment of FIG. 2, the tip 20 protrudes from the recessed edge 9.

Returning to FIG. 1, the die 2 further comprises a first and a second actuator element 22, 23, that are devices for actuating the first and, respectively, the second arm 18, 19. The first and a second actuator element 22, 23 are formed in proximity to the third and, respectively, the fourth lateral surface 7, 8 of the die 2.

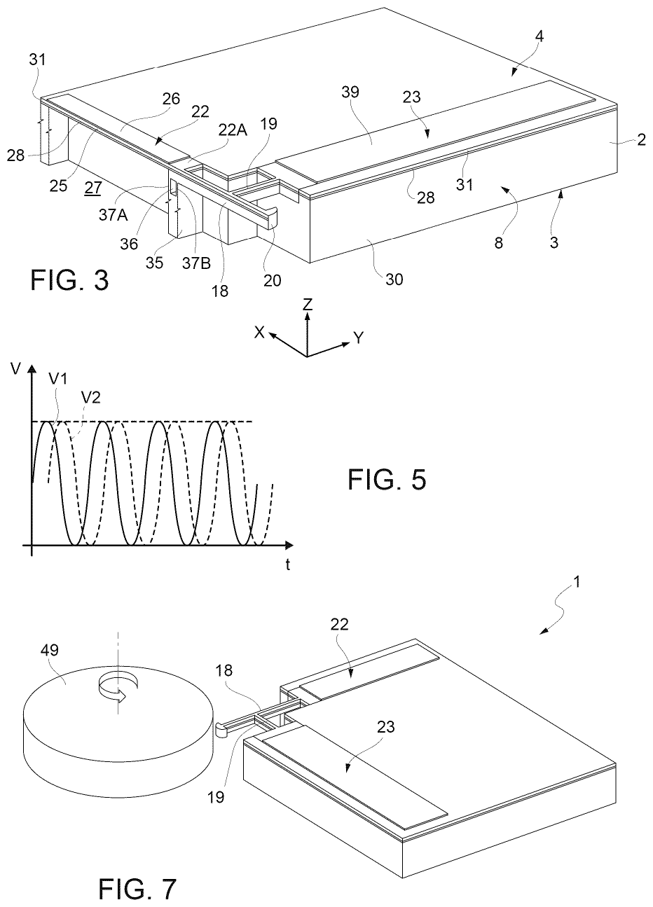

In detail, the first actuator element 22 (see also FIG. 3) comprises a first beam 25, a first piezoelectric stack 26 and a first constraint element 35.

The first actuator element 22 is coupled to one end of the first arm 18 at one own end portion 22A (where the first constraint element 35 is present).

The first beam 25 has its length extending parallel to the first lateral surface 7 (not visible in FIG. 3), and is aligned longitudinally with the first arm 18.

The first beam 25 here has a thickness (parallel to a third Cartesian axis Z of the coordinate system XYZ) which is smaller than the thickness of the first arm 18.

In detail, the first beam 25 is here of semiconductor material, such as silicon, and overlies a first beam cavity 27 extending through the d8ie 2, from the lower surface 3, parallel to the third main surface 7 (not visible in FIG. 3) which closes it to the outside of the die 2.

In the embodiment shown, an insulating layer 28 extends below the first beam 25.

The first beam 25 is constrained at the ends to the die 2.

The insulating layer 28 is a stop layer and separates a bulk region 30, of semiconductor material, from a structural layer 31, also of semiconductor material, which forms the first beam 25 and the upper portion of the first arm 18.

The bulk region 30, the insulating layer 28 and the structural layer 31 in practice form the die 2, whose upper surface 4 is defined by the structural layer 31. Other insulating and/or passivating layers may however cover the upper surface 4, in a manner not shown, possibly except for the zone of the arms 18, 19.

The first constraint element 35 is formed by a first rib (thus also indicated by 35) extending vertically throughout the height of the die 2, transversally to the first beam 25 and to the first arm 18.

The first rib 35 accommodates a chamber 36, placed in an intermediate position with respect to the height of the first rib 35; more precisely, the chamber 36 extends downwards (towards the lower surface 3 of the die 2) from a height corresponding to the lower edge of the first arm 18.

The chamber 36 delimits two thin walls 37A, 37B, parallel to each other and to a Cartesian plane YZ, and therefore transverse to both the first arm 18 and the first beam 25, which allow the deformation movement of the first beam 25, directed mainly parallel to the third Cartesian axis Z, to be transformed in an approximately linear movement, directed mainly parallel to the first Cartesian axis X, as discussed below.

As indicated above, the first arm 18 has a greater thickness than the first beam 25 and is formed, in addition to the structural layer 31, by the insulating layer 28 and part of the bulk region 30. The first arm 18 is thus suspended inside of the recessed edge 9.

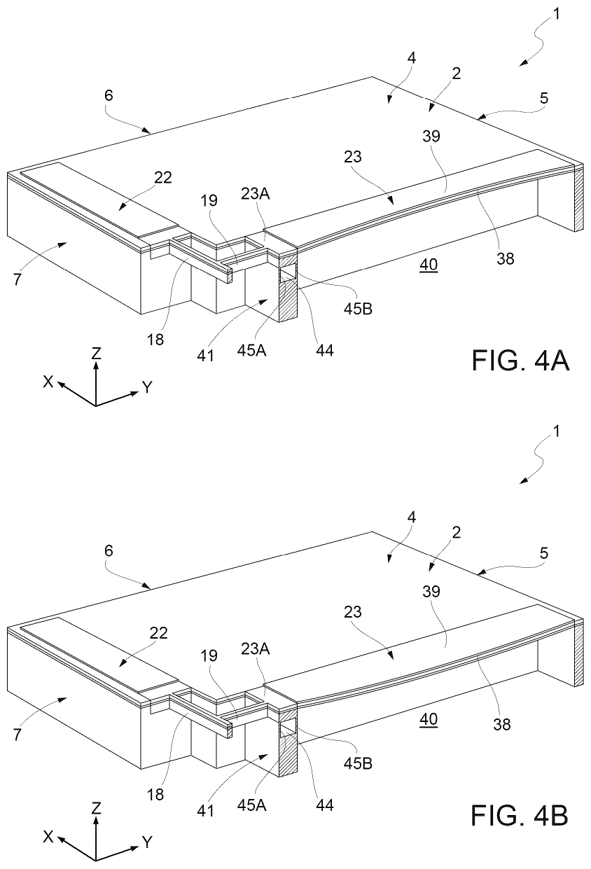

The second actuator element 23 (see also FIGS. 4A and 4B) has a structure similar to that of the first actuator element 22 and comprises a second beam 38, a second piezoelectric stack 39 and a second constraint element 41.

The second actuator element 23 is coupled to one end of the second arm at one own end portion 23A, where the second constraint element 41 is formed.

The second beam 38 has a length extending parallel to the second lateral surface 8 (not visible in FIGS. 4A and 4B) and overlies a second beam cavity 40, also extending longitudinally to the fourth main surface 8.

The second constraint element 41 is formed by a second rib (therefore also indicated by 41) extending vertically between the second beam 38 and the second arm 19, transversely thereto, and has a structure similar to the first rib 35.

The second rib 41 thus accommodates a second constraint chamber 44, placed at the same height as the first constraint chamber 36 and defining two second thin walls 45A and 45B, parallel to each other and to a Cartesian plane XZ.

By virtue of the shape of the arms 18, 19 and of the actuator elements 22, 23, the MEMS device 1 is able to generate an elliptical movement of the tip 20, as shown by the dashed line 48 of FIG. 2.

In fact, by applying AC voltages to the piezoelectric stacks 26, 39, the respective beams 25, 38 deform, expanding and contracting alternately upwards and downwards, as shown in FIGS. 4A and 4B, relating to two opposite deformation phases of the second actuator element 23.

The presence of the thin walls 37A, 37B and 45A, 45B in the ribs 35, 41 causes the deformations of the respective beams 25, 38 to transform into a substantially rectilinear displacement, in a plane parallel to the upper surface 4 of the die 2 and in the longitudinal directions of the respective beams 25, 38, of the ends of the same beams 25, 38 constrained to the ribs 35, 41. As shown in FIGS. 4A, 4B, this transformation is allowed by the ability of the thin walls 37A, 37B and 45A, 45B to deform.

The arms 18, 19 are thus controlled by the respective actuators 22, 23 to displace longitudinally, back and forth. For example, the first actuator element 22 is configured to move the first arm 18 along the first Cartesian axis X, and the second actuator element 23 is configured to move the second arm 19 along the second Cartesian axis Y.

Furthermore, the mutual rigid coupling of the first and the second arms 18, 19 at a connecting point indicated at 21 causes a deformation of the arms 18, 19 and a displacement in transverse direction of the same arms 18, 19. The connecting point 21 and the tip 20 at the end of the first arm 18 thus perform planar movements, with displacement components both along the first Cartesian axis and along the second Cartesian axis Y, where the displacement components are linked to the phase of the first and, respectively, of the second actuator 22, 23.

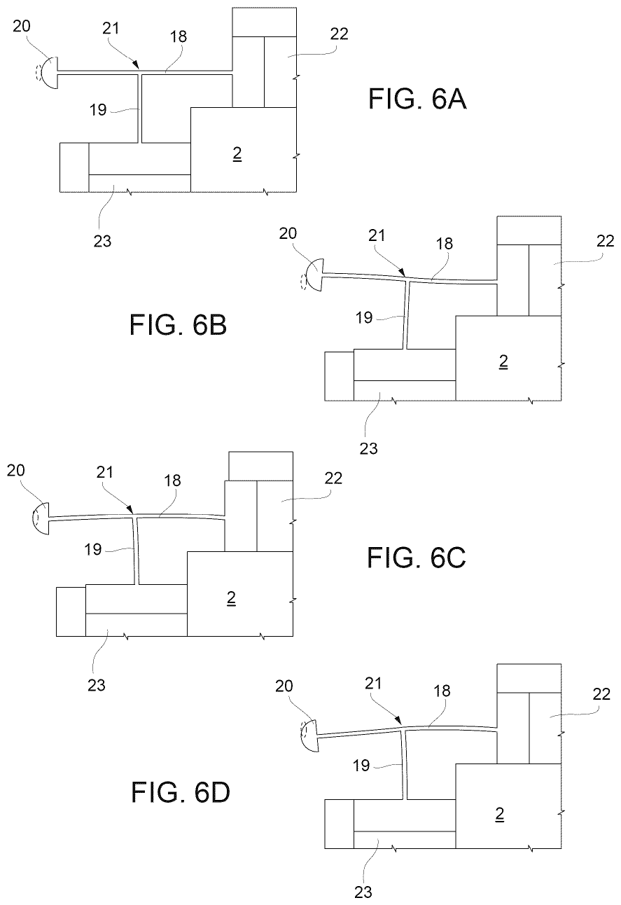

In particular, by applying AC voltages V1, V2 (FIG. 5) offset by 90°, for example to the first and, respectively, to the second actuator element 22, 23, the tip 20 performs a closed line movement, such as a circular or elliptical movement as shown in the sequence of FIGS. 6A-6D. In one embodiment, the AC voltages V1, V2 are generated and applied by a power device electrically coupled to the first and second actuator elements 22, 23.

For example, by applying AC voltages V1, V2 with an amplitude of 20 V (40 V peak-to-peak), at an ultrasonic frequency of, for example, 150 KHz, the beams 25, 38 may expand by less than 1 μm and the tip 20 may move with an elliptical movement having equal frequency with diagonals D1, D2 (FIG. 2) of, for example, D1=1.5 μm and D2=0.5 μm.

This elliptical movement may for example be used for driving a rotating element, for example a disk 49, as shown in FIG. 7.

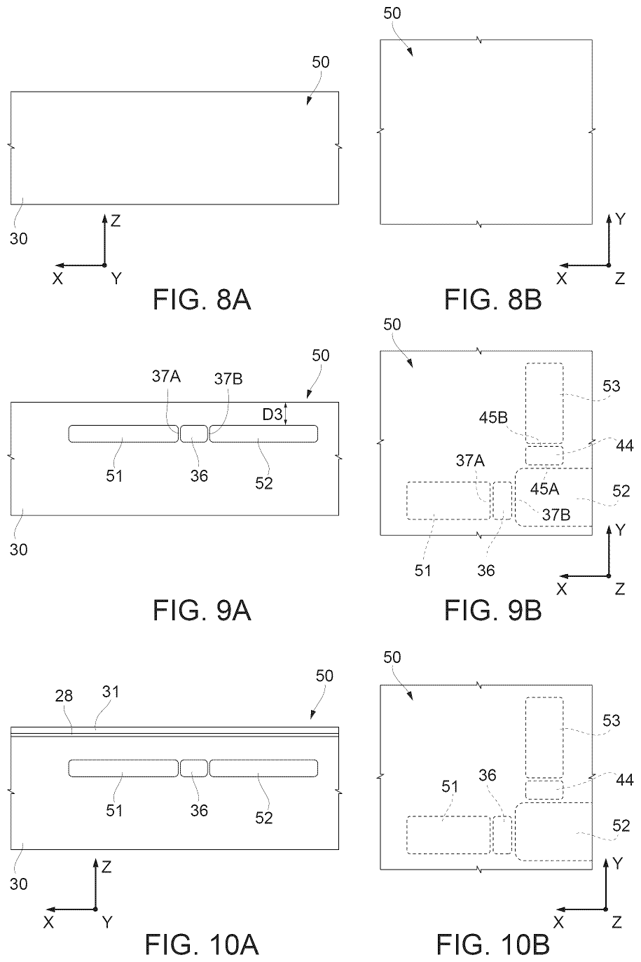

The MEMS device 1 may be manufactured as shown in FIGS. 8A-15A and 8B-15B.

FIGS. 8A and 8B show a wafer 50. The wafer 50 is a substrate of semiconductor

material, for example monocrystalline silicon. The wafer 50 has for example a thickness of 400 μm.

The wafer 50 is processed to form a plurality of buried chambers, as shown in FIGS. 9A and 9B. In particular, a first beam chamber 51, the first constraint chamber 36, an actuation cavity 52, the second constraint chamber 44 and a second beam chamber 53 are formed.

The first and the second beam chambers 51, 53 are arranged where the first and the second beams 25, 38 are to be formed; the actuation cavity 52 is formed where the actuation structure 10 is to be formed.

In practice, the first beam chamber 51, the first constraint chamber 36 and the actuation cavity 52 are aligned in a direction parallel to the first Cartesian axis X; the second beam chamber 53, the second constraint chamber 44 and the actuation cavity 52 are aligned in a direction parallel to the second Cartesian axis Y, as visible in FIG. 9B.

The chambers 51-53 and 36, 44 are formed for example as described in European patent EP 1577656 (corresponding to the U.S. Pat. No. 8,173,513) or in European patent EP 1830820 (corresponding to U.S. Pat. No. 7,294,536) by forming trenches and epitaxially growing a semiconductor layer which closes the trenches at the top, forming the cavities and chambers, or using another known process.

The chambers 51-53 and 36, 44 may for example have a depth (height in the direction of the third axis Z) of 10 μm, overlaid by a portion of semiconductor material having for example a thickness D3 of about 50 μm. The wafer 50 thus becomes thicker and forms the bulk region 30 of FIG. 1.

The first and the second beam chambers 51, 53 have equal area, for example (in the plan view of FIG. 9B) of 1.1×0.1 mm², rotated by 90° with respect to each other, with the first beam chamber 51 elongated parallel to the first Cartesian axis X and the second beam chamber 53 elongated parallel to the second Cartesian axis Y, as visible in FIG. 9B.

The constraint chambers 36, 44 also have equal dimensions, for example an area of about 50×100 μm², rotated by 90° with respect to each other, with the first constraint chamber 36 elongated parallel to the second Cartesian axis Y and the second constraint chamber 44 elongated parallel to the first Cartesian axis X, as also visible in FIG. 9B; the actuation cavity 52 may for example have an area of 0.8×0.8 μm².

Furthermore, the walls that separate the first beam chamber 51 from the first constraint chamber 36, the actuation cavity 52 from the first constraint chamber 36 and from the second constraint chamber 44 as well as the second constraint chamber 44 from the second beam chamber 53 may have a thickness of about 2 μm. It should be noted that these walls are the thin walls 37A, 37B, 45A and 45B (FIGS. 3 and 4A, 4B).

Then, FIGS. 10A, 10B, the insulating layer 28 is formed on the upper surface of the wafer 50, for example by depositing a silicon oxide layer, and the structural layer 31, for example of polycrystalline silicon, is deposited on the insulating layer 28.

For example, the insulating layer 28 has a thickness of about 1 μm and the structural layer 31 has a thickness of about 4 μm.

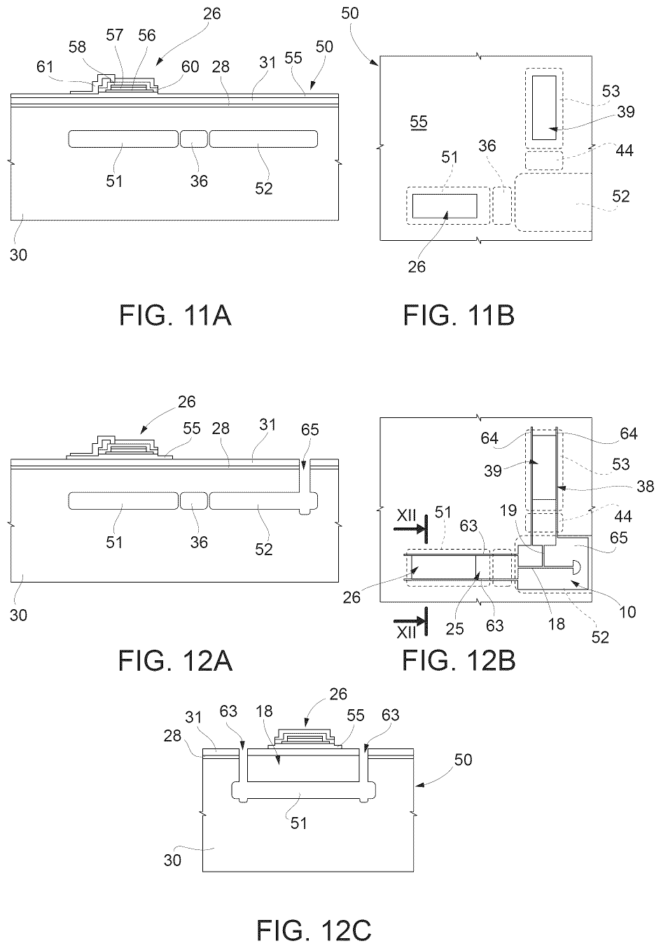

Then, FIGS. 11A and 11B, an insulation layer 55 is formed on the structural layer 31, for example by depositing a silicon oxide layer with a thickness of about 1 μm; and the piezoelectric stacks 26, 39 are formed on the insulation layer 55.

As shown in FIG. 11A for the piezoelectric stack 26, in a per se known manner, the piezoelectric stacks 26, 39 comprise a respective lower electrode 56, a respective piezoelectric layer 57 and a respective upper electrode 58.

The piezoelectric layer 57 may be of any suitable material, such as lead-zirconate-titanate PZT deposited via PVD (Physical Vapour Deposition) or as sol-gel, aluminum nitride (AIN) and scandium-doped aluminum nitride (AlScN). Alternatively, piezoelectric polymers may be used, such as for example polyvinylidene fluoride (PVDF) and its copolymers, or composites based on a piezoelectric polymeric matrix; the lower 56 and upper 58 electrodes may be of conductive material, for example of TiO₂/Pt, Pt or TiW or other materials compatible with the piezoelectric layer 57.

The piezoelectric stacks 26, 39 are also covered by one or more passivation layers, that are electrically insulating, generically indicated by 60 in FIG. 11A; the passivation layers 60 are opened to form contacts and electrical connection lines, that are electrically conductive, generically indicated by 61.

In FIGS. 12A-12C, the beams 25, 38 and the actuation structure 10 are defined. To this end, the wafer 50 is etched by a masked deep silicon etch, which extends through the structural layer 31, the insulating layer 28 and prosecutes in the bulk region 30 down to the first and the second beam chambers 51, 53 and the actuation cavity 52.

Thus, a first trench 63 (FIG. 12B), which surrounds and defines the first beam 25 (see also FIG. 12C), a second trench 64, which surrounds and defines the second beam 38, and an opening 65, in contiguity with the first and the second trenches 63, 64, which surrounds and defines the first arm 18, the second arm 19 and the tip 20, are formed.

Consequently, the arms 18, 19 and the tip 20 have a thickness given by the sum of the thicknesses of the structural layer 31, the insulating layer 28 and the portion of the bulk layer 30 overlying the actuation cavity 52, thus for example about 55 μm.

Furthermore, the beams 25, 38 may have a length of about 1.5 mm and a width of about 450 um and the arms 18, 19 may have a length of about 0.8 mm and a width of about 20 μm.

In this step, the insulation layer 55 is also partially removed, as visible in FIG. 12A.

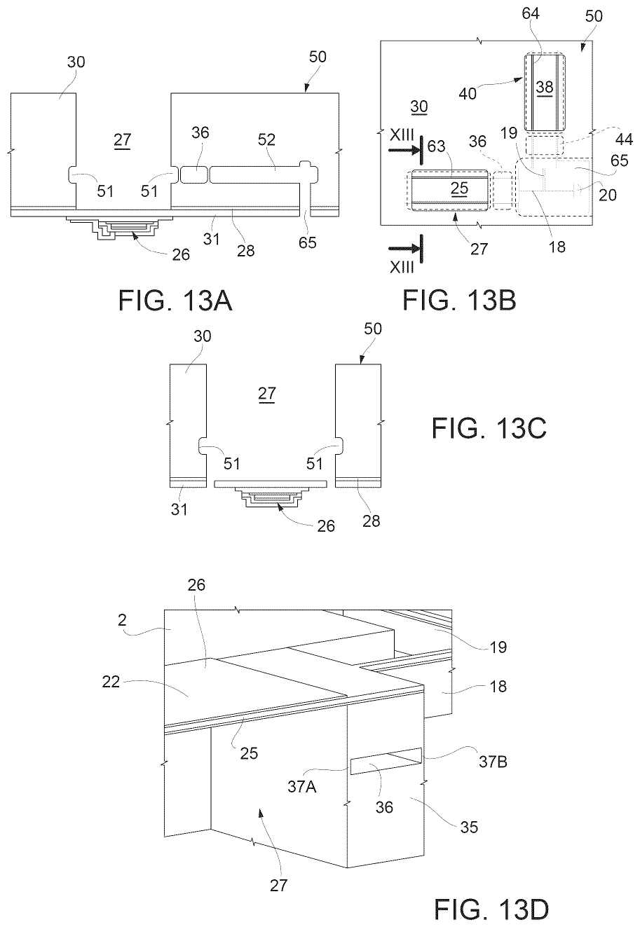

In FIGS. 13A-13D, the beams 25, 38 are freed. To this end, the wafer 50 is reversed and, through a masked deep silicon etch, part of the bulk region 30 is removed, approximately in the area of the first and the second beam chambers 51, 53, to the insulating layer 28. The first and the second beam cavities 27, 40 are thus formed.

In practice, the beams 25, 38 have the thickness of the structural layer 31. Consequently, the beams 18, 19 have a much lower thickness than the respective arms 18, 19.

FIG. 13D shows a detail of the first actuator element 22, and in particular shows the first rib 35, the first thin walls 37A, 37B, an end of the first beam 25 and of the first arm 18.

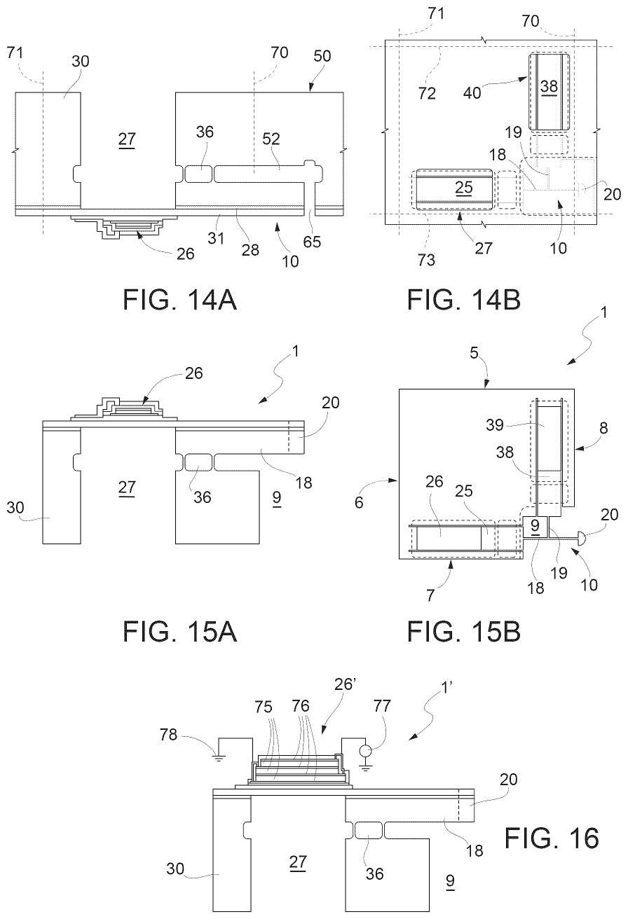

Subsequently, the wafer 50, still reversed, is diced, for example using a laser (advantageously, using the distealth dicing technique) or using a blade. In particular, dicing is performed along a first dicing line, indicated by 70 in FIGS. 14A and 14B, parallel to the second Cartesian axis Y. As noted, the dicing line 70 extends through the bulk region 30 and crosses the actuation cavity 52, as visible in FIGS. 14A, 14B.

This causes, inter alia, detachment of the part of the wafer 50 on the right in FIG. 14A, below (above in FIG. 14A) the actuation structure 10, forming the recessed edge 9, and formation of the fourth lateral surface 8, as shown in FIGS. 15A and 15B, showing the MEMS device 1 after dicing.

The wafer 50 is also diced along a second dicing line 71, on the left side of the structure shown in FIGS. 14A, 14B, parallel to the first dicing line 70, forming the second lateral surface 6 (FIG. 15B).

By further dicing along similar horizontal dicing lines 72, 73 perpendicular to the dicing lines 70, 71, above and below the structure shown in FIG. 14B, parallel to the first Cartesian axis X, the first and the third lateral surfaces 5, 7 are formed (FIG. 15B).

FIG. 16 shows an embodiment of a MEMS device, indicated by 1′, where the first piezoelectric stack, here indicated as 26′ is formed by a plurality of piezoelectric layers 75, having conductive layers 76 therebetween, alternatively forming the first and the second electrodes and connected respectively to a driving voltage source 77 and to ground 78.

Obviously, in this case, the second piezoelectric stack 38 also has a multilayer structure.

The described MEMS device 1, 1′ may thus function as an integrated micromotor, that may be manufactured not only with reduced dimensions and thus may be used in apparatus with small dimensions, but may also operate in a controllable manner and with high dynamics, thanks to the reduced inertia and to the high movement activation and interruption speed.

Finally, it is clear that modifications and variations may be made to the MEMS device and the manufacturing process described and illustrated herein without thereby departing from the scope of the present disclosure.

For example, the MEMS device may be used as a micro-positioner of lenses or mirrors or other optical surfaces, in optical applications; as a micro-actuator of micromechanical systems; as a micro-switch in optical waveguides and other micro-paths; as a micro-mixer, for example coupled to a paddle for micro-fluidic applications; and in general in all applications where an elliptical micro-movement is desired.

The tip or punch 20 may be replaced by any other movable member, in particular suitable for the desired application.

The connecting point 21 may be different from what shown, for example arranged in proximity to both arms 18, 19, to obtain circular movements.

The tip might move along a generic closed line, not necessarily circular or elliptical, calibrating the dimensions of the arms and their connecting point and/or the driving offset, for example along an eight-shaped or infinite-shaped path.

A MEMS device (1; 1′) may be summarized as including: a first actuator element (22), of piezoelectric type, having an end portion (22A) and configured to generate an alternate, approximately linear movement of its end portion, along a first direction; a second actuator element (23), of piezoelectric type, having an end portion (23A) and configured to generate an alternate, approximately linear movement of its end portion, along a second direction, transverse to the first direction; a first arm (18), having a first and a second end, the first end of the first arm being integral with the end portion of the first actuator element; a second arm (19), extending transversely to the first arm (18) and having a first and a second end, the first end of the second arm being integral with the end portion of the second actuator element, the second end of the second arm being integral with the first arm; the first and the second actuator elements (22, 23) being configured to be driven in an offset manner, thereby the second end of the first arm (18) performs a closed-line movement.

The first arm (18) extends in the first direction and the second arm (19) extends in the second direction.

The first actuator element (22) comprises a first beam (25), a first piezoelectric stack (26) extending along the first beam, and a first constraint element (35), the first constraint element being deformable and coupled to the end portion (22A) of the first actuator element, the second actuator element (23) comprises a second beam (38), a second piezoelectric stack (39) extending along the second beam, and a second constraint element (41), the second constraint element being deformable and coupled to the end portion (23A) of the second actuator element (22), the first and the second constraint elements being configured to transform deformation movements of the respective beam in planar movements of the respective arm.

The planar movements of the first and the second arms (18, 19) are approximately longitudinal movements.

The first and the second constraint elements (35, 41) comprise each at least one wall (37A, 45A) extending in a transverse plane with respect to the respective beam (25, 38).

Each beam (25, 38) has a first thickness, and each arm (18, 19) has a second thickness, greater than the first thickness.

The MEMS device comprises a die (2) having a first and a second main surface (3, 4) and at least two adjacent lateral surfaces (7, 8), wherein the first actuator element (22) is delimited by a first beam cavity (27) extending from the first main surface (3) to the first beam (25) and the second actuator element (23) is delimited by a second beam cavity (40) extending from the first main surface (3) to the second beam (38).

Each actuator element (22, 23) extends close to a respective lateral surface (7, 8) of the adjacent lateral surfaces, the adjacent lateral surfaces form a recessed edge (9), the first and the second arms (18, 19) extend in the recessed edge (9).

The MEMS device comprises a first and a second rib (35, 41) forming the first and, respectively, the second constraint element, the first rib (35) extending between the first beam cavity (27) and the recessed edge (9) and the second rib (41) extending between the second beam cavity (40) and the recessed edge (9).

The first and the second ribs (35, 41) each have a respective constraint chamber (36, 44) delimited by the at least one wall (37A, 45A) and by a second wall (37B, 45B), the second wall of each rib extending transversely to the respective beam (25, 38), at a distance from the respective at least one wall.

The second arm (19) is constrained to the first arm (18) at an intermediate point 21 of the first arm, in particular at a central point of the first arm.

The MEMS device comprises a tip or punch (20) at the second end of the first arm (18).

A process for manufacturing a MEMS device (1), may be summarized as including: forming, in a wafer (50) comprising semiconductor material, a first actuator element (22), of piezoelectric type, having an end portion (22A) and configured to generate an alternate, approximately linear movement of its end portion, along a first direction; a second actuator element (23), of piezoelectric type, having an end portion (23A) and configured to generate an alternate, approximately linear movement of its end portion, along a second direction, transverse to the first direction; a first arm (18), having a first and a second end, the first end of the first arm being integral with the end portion of the first actuator element; a second arm (19), having a first and a second end, the first end of the second arm being integral with the end portion of the second actuator element, the second end of the second arm being integral with the first arm; the first and the second actuator elements being configured to be driven in an offset manner, so that the second end of the first arm performs a closed-line movement.

The process comprises: forming, in a bulk region (30) of semiconductor material, a first beam chamber (51), a second beam chamber (53), a first constraint chamber (36), a second constraint chamber (44) and an actuator chamber (52); forming a stopping layer (28) on the bulk region; forming a structural layer (31) on the stopping layer; forming a first piezoelectric stack (26) on the structural layer, vertically aligned to the first beam chamber; forming a second piezoelectric stack (39) on the structural layer, vertically aligned to the second beam chamber; defining the structural layer, the stopping layer and the bulk layer to define the first arm (18), the second arm (19), the first beam (25) and the second beam (38); freeing the first and the second beams (25, 38), by removing a portion of the bulk region (30) underlying the first and the second beams; and removing a portion of the bulk region (30) below the actuation chamber (52).

Removing a portion of the bulk region (30) comprises dicing the wafer (50) along a first and a second line (70, 71) intersecting the actuator chamber (52).

The various embodiments described above can be combined to provide further embodiments. These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A micro-electromechanical system (MEMS) device comprising:
a first actuator element of a piezoelectric type, the first actuator element having an end portion and configured to generate an alternate, approximately linear movement of the end portion of the first actuator element, along a first direction;
a second actuator element of a piezoelectric type, the second actuator element having an end portion and configured to generate an alternate, approximately linear movement of the end portion of the second actuator element, along a second direction, transverse to the first direction;
a first arm having a first and a second end, the first end of the first arm being integral with the end portion of the first actuator element; and
a second arm extending transversely to the first arm and having a first and a second end, the first end of the second arm being integral with the end portion of the second actuator element, the second end of the second arm being integral with the first arm,
the first and the second actuator elements being configured to be driven in an offset manner such that the second end of the first arm performs a closed-line movement.

2. The MEMS device according to claim 1, wherein the first arm extends in the first direction and the second arm extends in the second direction.

3. The MEMS device according to claim 1, wherein
the first actuator element includes a first beam, a first piezoelectric stack extending along the first beam, and a first constraint element, the first constraint element being deformable and coupled to the end portion of the first actuator element, the first constraint element being configured to transform deformation movements of the first beam in to planar movements of the first arm, and
the second actuator element includes a second beam, a second piezoelectric stack extending along the second beam, and a second constraint element, the second constraint element being deformable and coupled to the end portion of the second actuator element, the second constraint element being configured to transform deformation movements of the second beam in to planar movements of the second arm.

4. The MEMS device according to claim 3, wherein the planar movements of the first and the second arms are approximately longitudinal movements.

5. The MEMS device according to claim 3, wherein the first constraint element includes at least one wall extending in a transverse plane with respect to the first beam, and the second constraint element includes at least one wall extending in a transverse plane with respect to the second beam.

6. The MEMS device according to claim 3, wherein each of the first and second arms has a greater thickness than the first and second beams, respectively.

7. The MEMS device according to claim 3, comprising:
a die having a first and a second main surface and at least two adjacent lateral surfaces, the first actuator element is delimited by a first beam cavity extending from the first main surface to the first beam, the second actuator element is delimited by a second beam cavity extending from the first main surface to the second beam.

8. The MEMS device according to claim 7, wherein each of the first and second actuator elements extends close to a respective lateral surface of the adjacent lateral surfaces, the adjacent lateral surfaces form a recessed edge, the first and the second arms extend in the recessed edge.

9. The MEMS device according to claim 8, comprising:
first and second ribs forming the first and second constraint elements, respectively, the first rib extending between the first beam cavity and the recessed edge, the second rib extending between the second beam cavity and the recessed edge.

10. The MEMS device according to claim 9, wherein
the first constraint element includes at least one wall extending in a transverse plane with respect to the first beam, and the second constraint element includes at least one wall extending in a transverse plane with respect to the second beam, and
the first rib has a constraint chamber delimited by the at least one wall of the first constraint element and by a wall extending transversely to the first beam, at a distance from the at least one wall of the first constraint element, and
the second rib has a constraint chamber delimited by the at least one wall of the second constraint element and by a wall extending transversely to the second beam, at a distance from the at least one wall of the second constraint element.

11. The MEMS device according to claim 1, wherein the second arm is constrained to the first arm at an intermediate point of the first arm.

12. The MEMS device according to claim 1, comprising:
a tip or punch at the second end of the first arm.

13. A process for manufacturing a MEMS device, comprising:
forming, in a wafer including semiconductor material, a first actuator element of a piezoelectric type, the first actuator element having an end portion and configured to generate an alternate, approximately linear movement of the end portion of the first actuator element, along a first direction;
forming, in the wafer, a second actuator element of a piezoelectric type, the second actuator having an end portion and configured to generate an alternate, approximately linear movement of the end portion of the second actuator element, along a second direction, transverse to the first direction;
forming a first arm having a first and a second end, the first end of the first arm being integral with the end portion of the first actuator element; and
forming a second arm having a first and a second end, the first end of the second arm being integral with the end portion of the second actuator element, the second end of the second arm being integral with the first arm,
the first and the second actuator elements being configured to be driven in an offset manner such that the second end of the first arm performs a closed-line movement.

14. The process according to claim 13, comprising:
forming, in a bulk region of the wafer, a first beam chamber, a second beam chamber, a first constraint chamber, a second constraint chamber and an actuator chamber;
forming a stopping layer on the bulk region;
forming a structural layer on the stopping layer;
forming a first piezoelectric stack on the structural layer, the first piezoelectric stack vertically aligned to the first beam chamber;
forming a second piezoelectric stack on the structural layer, the second piezoelectric stack vertically aligned to the second beam chamber;
defining the structural layer, the stopping layer, and the bulk region to define the first arm, the second arm, a first beam, and a second beam;
freeing the first and the second beams by removing a portion of the bulk region underlying the first and the second beams; and
removing a portion of the bulk region below the actuation chamber.

15. The process according to claim 14, wherein removing the portion of the bulk region includes dicing the wafer along a first and a second line intersecting the actuator chamber.

16. A device comprising:
a substrate having a first lateral surface extending along a first direction, and a second lateral surface extending along a second direction transverse to the first direction;
a first actuator element positioned at the first lateral surface, the first actuator element including a first end portion;
a first arm coupled to the first end portion and extending along the first direction, the first actuator element configured to move the first arm;
a second actuator element positioned at the second lateral surface, the second actuator element including a second end portion; and
a second arm coupled to the second end portion and the first arm, the second arm extending along the second direction, the second actuator element configured to move the second arm.

17. The device according to claim 16 wherein the first end portion and the second portion includes a first chamber and a second chamber, respectively.

18. The device according to claim 16 wherein the first actuator element includes a first beam configured to move along a third direction transverse to the first and second directions, and the second actuator element includes a second beam configured to move along the third direction.

19. The device according to claim 18 wherein the first actuator element includes a first cavity underlying the first beam, and the second actuator element includes a second cavity underlying the second beam.

20. The device according to claim 18 wherein the first actuator element includes a first piezoelectric stack on the first beam, and the second actuator element includes a second piezoelectric stack on the second beam.
